(19) United States
(12) Patent Application Publication
(10) Pub. No.: US 2018/0122290 A1
(43) Pub. Date: May 3, 2018

(54) SOURCE DRIVING CIRCUIT, SOURCE DRIVING CHIP AND DISPLAY APPARATUS

(71) Applicant: BOE TECHNOLOGY GROUP CO., LTD., Beijing (CN)

(72) Inventor: Chul Gyu Jung, Beijing (CN)

(21) Appl. No.: 15/678,076

(22) Filed: Aug. 15, 2017

(30) Foreign Application Priority Data
Oct. 28, 2016 (CN) 201610966562.0

(51) Int. Cl. G09G 3/20

(52) U.S. Cl. CPC G09G 3/2092; G09G 2310/027; G09G 2310/08

(57) ABSTRACT

The present disclosure provides a source driving circuit, a source driving chip and a display apparatus. The source driving circuit comprises a first conversion circuit, a second conversion circuit, a comparison circuit, a switch control circuit and an output circuit. The first conversion circuit receives a data signal, and converts it into a first analog signal. The comparison circuit compares a current frame of the data signal with a previous frame, and outputs the pre-charging voltage signal. The second conversion circuit converts the pre-charging voltage signal into a second analog signal. The switch control circuit outputs the second analog signal at a rising edge of the control signal and outputs the first analog signal at a falling edge. The output circuit outputs the received first and second analog signals to a corresponding data line of a display panel.

### CROSS-REFERENCE TO RELATED APPLICATION(S)

This application claims priority to the Chinese Patent Application No. 201610966562.0, filed on Oct. 28, 2016, which is incorporated herein by reference in its entirety.

### TECHNICAL FIELD

The present disclosure relates to the field of display technology, and more particularly, to a source driving circuit, a source driving chip, and a display apparatus.

### BACKGROUND

As size and a resolution of display panels increases, a transmission distance of a data signal on a data line gradually increases, and the load carried on corresponding data signal also gradually increases, which may lead to a problem of insufficient charging time in a frame time, thereby affecting display quality of the display product.

Therefore, it is desired by those skilled in the art that new technologies that can achieve an increased charging rate of the display panel and hence enhanced display quality of the display panel will emerge shortly.

### SUMMARY

The embodiments of the present disclosure provide a source driving circuit, a source driving chip, and a display apparatus, which are used to increase the charging rate of the display panel and thereby improve the display quality of the display panel.

The embodiments of the present disclosure provide a source driving circuit, comprising: a first conversion circuit, a second conversion circuit, a comparison circuit, a switch control circuit and an output circuit, wherein

the first conversion circuit is configured to receive a data signal of an image to be displayed, and convert the data signal into a first analog signal;

the comparison circuit is configured to compare a current frame of the data signal with a previous frame of the data signal, generate a pre-charging voltage signal according to a result of the comparison, and output the pre-charging voltage signal to the second conversion circuit;

the second conversion circuit is configured to convert the pre-charging voltage signal into a second analog signal;

the switch control circuit is configured to receive the first analog signal and the second analog signal, output the second analog signal to the output circuit at a rising edge of the control signal and output the first analog signal to the output circuit at a falling edge of the control signal; and

the output circuit is configured to output the received first analog signal and second analog signal to a corresponding data line of a display panel.

In an embodiment, in the source driving circuit according to the embodiments of the present disclosure, the comparison circuit is further configured to:

compare the current frame of the data signal with the previous frame of the data signal;

generate a pre-charging voltage signal greater than the current frame of the data signal when the current frame of the data signal is greater than the previous frame of the data signal, and output the generated pre-charging voltage signal to the second conversion circuit; and

generate a pre-charging voltage signal less than the current frame of the data signal when the current frame of the data signal is less than the previous frame of the data signal, and output the generated pre-charging voltage signal to the second conversion circuit.

In an embodiment, in the source driving circuit according to the embodiments of the present disclosure, the switch control circuit comprises a first switch circuit and a second switch circuit, wherein

the first switch circuit is configured to be turned on at the rising edge of the control signal to output the second analog signal to the output circuit; and

the second switch circuit is configured to be turned on at the falling edge of the control signal to output the first analog signal to the output circuit.

In an embodiment, in the source driving circuit according to the embodiments of the present disclosure, a time interval between the rising edge and the falling edge of the control signal increases with a transmission distance of the data signal on the data line.

In an embodiment, the source driving circuit according to the embodiments of the present disclosure further comprises: a storage circuit and a grayscale voltage generation circuit, wherein

the storage circuit is configured to store the previous image of the data signal of the image be displayed; and

the grayscale voltage generation circuit is configured to provide a corresponding grayscale voltage when the first analog signal and the second analog signal are output to the switch control circuit, respectively.

In an embodiment, in the source driving circuit according to the embodiments of the present disclosure, the first conversion circuit and the second conversion circuit are digital-to-analog converters.

In an embodiment, in the source driving circuit according to the embodiments of the present disclosure, the comparison circuit is a comparator.

In an embodiment, in the source driving circuit according to the embodiments of the present disclosure, the output circuit is an output buffer.

The embodiments of the present disclosure provide a source driving chip comprising the source driving circuit according to the embodiments of the present disclosure.

The embodiments of the present disclosure provide a display apparatus comprising the source driving chip according to the embodiments of the present disclosure.

In an embodiment, the display apparatus further comprises: a control signal controller, configured to increase a time interval between the rising edge and falling edge of the control signal with a transmission distance of the data signal on the data line.

### BRIEF DESCRIPTION OF THE DRAWINGS

FIG. 1 is a structural diagram of a display apparatus in a conventional art;

FIG. 2 is a structural diagram of a source driving circuit according to an embodiment of the present disclosure;

FIG. 3 is a diagram showing loading timing for a data signal according to an embodiment of the present disclosure;

FIG. 4 is a diagram showing loading timing for a data signal in the conventional art;

FIG. 5 is a specific structural diagram of a source driving circuit according to an embodiment of the present disclosure;

FIG. 6 is a structural diagram of a simulation circuit according to an embodiment of the present disclosure; and

FIG. 7 is a diagram of a simulation waveform of a simulation circuit according to an embodiment of the present disclosure.

### DETAILED DESCRIPTION

Hereinafter, specific embodiments of the source driving circuit, the source driving chip, and the display apparatus according to the embodiments of the present disclosure will be described in detail with reference to the accompanying drawings.

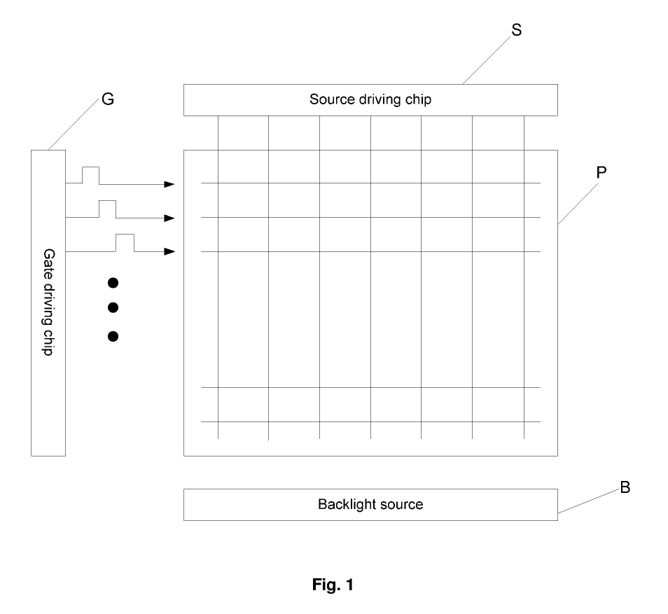

Firstly, as shown in FIG. 1, a display apparatus in FIG. 1 primarily comprises a display panel P for displaying, a source driving chip S, a gate driving chip G, and a backlight source B for providing backlight. A driving manner for the display panel to realize normal display is as follows: the gate driving chip inputs scanning signals to various gate lines of the display panel row by row to achieve progressive scanning, and the source driving chip loads data signals onto data lines to achieve refreshing frame by frame. In this way, normal display of the display panel is realized through cooperation between the gate driving chip and the source driving chip. However, as size and resolution of the display panel increases, load of the display panel in a direction in which a scanning signal is loaded along a gate line and a direction in which a data signal is loaded along a data line gradually increases, which leads to a significantly insufficient charging time. For example, in a case that the resolution of the display panel is 8K (7680×4320) and the frame rate of the display panel is 60 hz, a loading time for a scanning signal on a gate line is (1000/60/4320)ms which is about 3.7 us. However, due to restrictions in terms of production materials (Al and Cu) and process design characteristics, full charging of a data line cannot be realized within merely 3.7 us, which may cause the display panel to have a low charging rate, thereby affecting the display quality of the entire display screen.

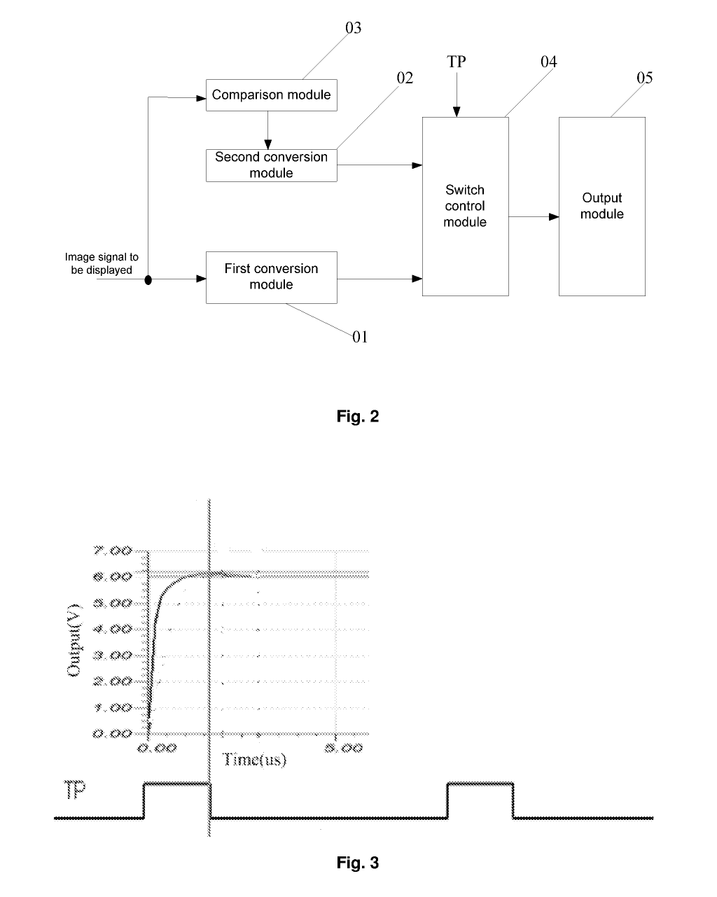

The embodiments of the present disclosure provide a source driving circuit, which as shown in FIG. 2, may comprise a first conversion circuit 01, a second conversion circuit 02, a comparison circuit 03, a switch control circuit 04 and an output circuit 05, wherein the first conversion circuit 01 is configured to receive a data signal of an image to be displayed, and convert the data signal into a first analog signal; the comparison circuit 03 is configured to compare a current frame of the data signal with a previous frame of the data signal, generate a pre-charging voltage signal according to a result of the comparison, and output the pre-charging voltage signal to the second conversion circuit 02; the second conversion circuit 02 is configured to convert the pre-charging voltage signal into a second analog signal; the switch control circuit 04 is configured to receive the first analog signal and the second analog signal, output the second analog signal to the output circuit 05 at a rising edge of the control signal TP and output the first analog signal to the output circuit 05 at a falling edge of the control signal TP; and the output circuit 05 is configured to output the received first analog signal and second analog signal to a corresponding data line of a display panel.

In particular, in the conventional art, in order to solve the problem of insufficient charging as the size and the resolution of the display panel increase, a number of data lines of the display panel is usually doubled, that is, two data lines are arranged between two adjacent columns of pixels, and a number of source driving chips is also doubled. When the display panel is driven for display, the two adjacent gate lines are required to be driven simultaneously, and data lines between two adjacent columns of pixels load data signals onto corresponding pixels respectively to achieve normal driving of the display panel. However, in the above solution, the cost of the wiring design and production of the display panel has been correspondingly increased. In contrast, in the source driving circuit according to the embodiments of the present disclosure, the comparison circuit compares a current frame of the data signal with a previous frame of the data signal and generates a corresponding pre-charging voltage signal, the second conversion circuit converts the pre-charging voltage signal into a second analog signal after a rising edge of a control signal arrives and outputs the second analog signal, and the first conversion circuit converts the current frame of the data signal into a first analog signal after a falling edge of the control signal arrives and outputs the first analog signal corresponding to the current frame of the data signal. In this way, under the control of the control signal, the data signals are loaded onto a data line respectively in two periods of time in a frame time. The charging efficiency can be effectively improved in this way. Further, there is no need for an additional wiring design for the source driving circuit according to the embodiments of the present disclosure, which can save the manufacturing cost.

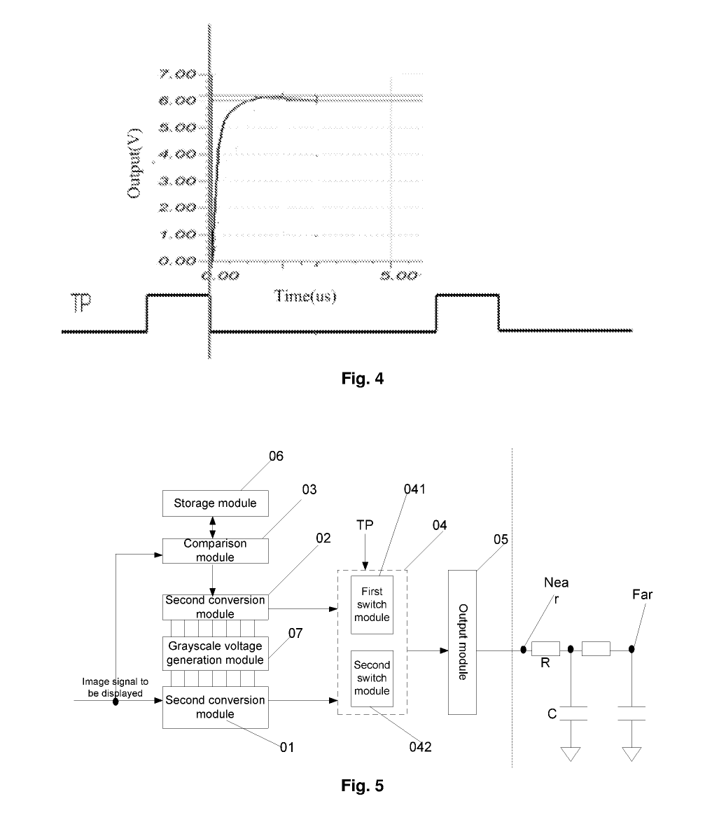

In addition, as shown in FIG. 4, in the conventional art, a corresponding data signal is loaded onto a data line only after a falling edge of a control signal TP arrives, while in the source driving circuit according to the present disclosure, the data signals are loaded onto the data line respectively in two periods of time. For example, as shown in FIG. 3, pre-charging is performed in a time interval between a rising edge and a falling edge of a control signal TP, and a current frame of the data signal is loaded after the falling edge of the control signal TP arrives. In this way, the problem of insufficient charging can be effectively improved, thereby enhancing the display quality of the display panel.

In a specific implementation, in the source driving circuit according to the embodiments of the present disclosure, the comparison circuit may be further configured to: compare the current frame of the data signal with the previous frame of the data signal; generate a pre-charging voltage signal greater than the current frame of the data signal when the current frame of the data signal is greater than the previous frame of the data signal and output the generated pre-charging voltage signal to the second conversion circuit; and generate a pre-charging voltage signal less than the current frame of the data signal when the current frame of the data signal is less than the previous frame of the data signal and output the generated pre-charging voltage signal to the second conversion circuit.

Specifically, the comparison circuit compares the current frame of the data signal with the previous frame of the data signal, and generates a pre-charging voltage signal greater than the current frame of the data signal when the current frame of the data signal is greater than the previous frame of the data signal and outputs the generated pre-charging voltage signal to the second conversion circuit. The second conversion circuit converts the pre-charging voltage signal and outputs a second analog signal, thereby realizing loading of the pre-charging voltage signal onto the data line, so that a level of a voltage signal on the data line increases as soon as possible. After the falling edge of the control signal arrives, the first conversion circuit then loads the current frame of the data signal onto the data line. In this way, the loading of the signal onto the data line can be completed rapidly. Similarly, when the current frame of the data signal is less than the previous frame of the data signal, a pre-charging voltage signal less than the current frame of the data signal is generated and the generated pre-charging voltage signal is output to the second conversion circuit. The second conversion circuit converts the pre-charging voltage signal and outputs a second analog signal, thereby realizing loading of the pre-charging voltage signal onto the data line, so that the level of the voltage signal on the data line decreases as soon as possible. After the falling edge of the control signal arrives, the first conversion circuit then loads the current frame of the data signal onto the data line. In this way, the loading of the signal onto the data line can be completed rapidly.

In a specific implementation, in the source driving circuit according to the embodiments of the present disclosure, as shown in FIG. 5, the switch control circuit may comprise a first switch circuit 041 and a second switch circuit 042, wherein the first switch circuit 041 is configured to be turned on at the rising edge of the control signal TP to output the analog signal of the second conversion circuit 02 to the output circuit 05; and the second switch circuit 042 is configured to be turned on at the falling edge of the control signal TP to output the analog signal of the first conversion circuit 01 to the output circuit 05. Specifically, the switch control circuit may comprise two switch circuits, and enable the first switch circuit and the second switch circuit to be turned on in a time division manner under the control of the control signal to output the first analog signal and the second analog signal respectively in corresponding periods of time, i.e., the first switch circuit is turned on at the rising edge of the control signal to output the second analog signal, so as to realize loading of the pre-charging voltage signal onto the data line; and the second switch circuit is turned on at the falling edge of the control signal to output the first analog signal, so as to realize loading of the current frame of the data signal onto the data line. This is advantageous for improving the charging efficiency of the display panel, thereby improving the display quality of the display panel.

In a specific implementation, in the source driving circuit according to the embodiments of the present disclosure, the time interval between the rising edge and the falling edge of the control signal increases with a transmission distance of the data signal on the data line. Specifically, as shown in FIG. 5, as each signal line itself has a load resistor R and there is a parasitic capacitor C among various signal lines, there will be a Resistor-Capacitor (RC) delay for any signal transmission on each signal line. A corresponding load value for the data signal gradually increases with the transmission distance thereof on each data line on the display panel. That is, as distance of the data line varies from a near end thereof relative to the source driving circuit to a far end thereof relative to the source driving circuit, a corresponding delay for the transmission of the data signal increases accordingly, which may lead to insufficient charging. In addition, as load values of various models of display panels are different, i.e., RC delays are different, different charging time will be required. In order to ensure the charging rate of the display panel, the greater the load value of the display panel is, i.e., the greater the RC value is, the longer the required charging time should be.

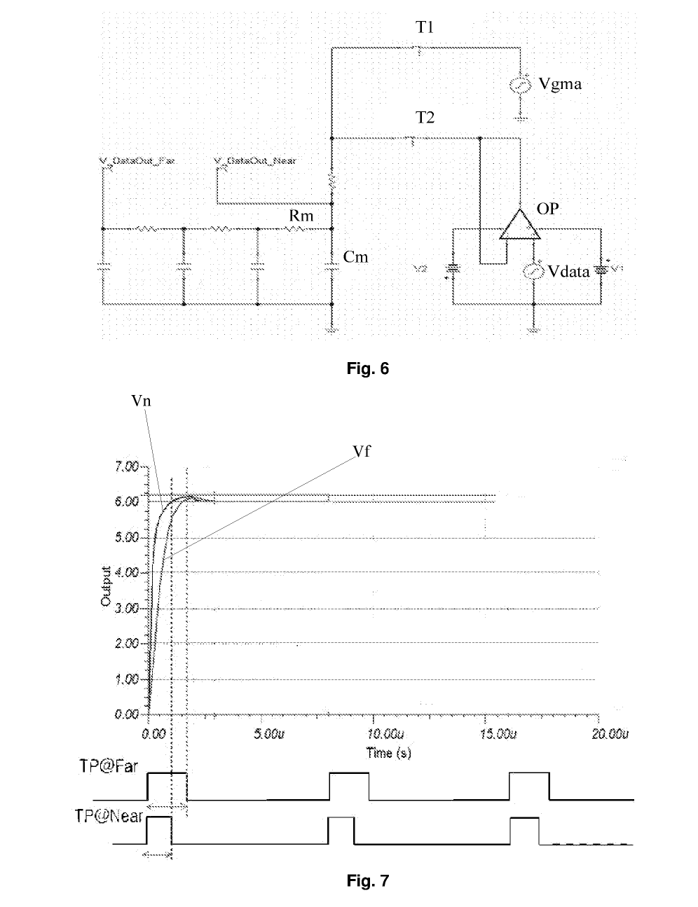

The present disclosure will be described below using a simulation circuit shown in FIG. 6 and a schematic diagram of a simulation waveform shown in FIG. 7. In the source driving circuit according to the embodiments of the present disclosure, the interval between the rising edge and the falling edge of the control signal increases with the transmission distance of the data signal on the data line. The simulation circuit shown in FIG. 6 primarily comprises: a load resistor Rm, a load capacitor Cm, a comparator OP, a switch T1, a switch T2, a power source V1 and a power source V2. Working principles and realization functions of various devices are the same as those in the conventional art, and the detailed description thereof will be omitted here. Specifically, an analog signal Vdata required to be loaded onto the data line is input to a non-inverting input terminal of the comparator OP, a grayscale voltage signal Vgma is input via the switch T1, and the simulation waveform shown in FIG. 7 can be obtained through simulation.

A data signal is loaded by the source driving circuit to each data line. A corresponding load value for the data signal gradually increases with the transmission distance thereof on each data line on the display panel. That is, as distance of the data line varies from a near end thereof relative to the source driving circuit to a far end thereof relative to the source driving circuit, a corresponding delay for the transmission of the data signal increases accordingly. Therefore, a duty ratio of the control signal may be set and the control signal is provided by a clock controller. In this way, the duty ratio of the control signal is set to enable the time interval between the rising edge and the falling edge of the control signal to increase with the transmission distance of the data signal on the data line, so that in a process of loading the data signal, a loading time for the pre-charging voltage signal increases with the transmission distance of the data signal. Thus, a sufficient pre-charging time is provided for loading of a data signal at the far end of the data line, which ensures the charging rate at the far end of the data line relative to the source driving circuit, thereby improving the charging efficiency of the display panel.

In a specific implementation, the source driving circuit according to the embodiments of the present disclosure may, as shown in FIG. 5, further comprise a storage circuit 06 and a grayscale voltage generation circuit 07. The storage circuit 06 is configured to store a previous frame of the data signal of the image to be displayed; and the grayscale voltage generation circuit 07 is configured to provide a corresponding grayscale voltage when the first analog signal and the second analog signal are output to the switch control circuit, respectively. In addition, in the source driving circuit according to the embodiments of the present disclosure, functions of the first and second conversion circuits can be realized by digital-to-analog converters, the function of the comparison circuit can be realized by a comparator, and the function of the output circuit can be realized by an output buffer. As the structures and functions of the digital-to-analog converter, the comparator and the output buffer are the same as those in the conventional art, the detailed description thereof will be omitted here.

Based on the same conception, the embodiments of the present disclosure provide a source driving chip comprising the source driving circuit according to the embodiments of the present disclosure. As the principle of the source driving chip for solving the problem is similar to that of the source driving circuit, the implementation of the source driving chip can be known with reference to the implementation of the source driving circuit, and the repeated description thereof will be omitted here.

Based on the same conception, the embodiments of the present disclosure provide a display apparatus comprising the source driving chip according to the embodiments of the present disclosure. The display apparatus can be applied to any product or component having a display function such as a mobile phone, a tablet computer, a television set, a display, a notebook computer, a digital photo frame, a navigator etc. As the principle of the display apparatus for solving the problem is similar to that of the source driving chip, the implementation of the display apparatus can be known with reference to the implementation of the source driving chip, and the repeated description thereof will be omitted here.

The embodiments of the present disclosure provide a source driving circuit, a source driving chip and a display apparatus. The source driving circuit comprises a first conversion circuit, a second conversion circuit, a comparison circuit, a switch control circuit and an output circuit, wherein the first conversion circuit is configured to receive a data signal of an image to be displayed, and convert the data signal into a first analog signal; the comparison circuit is configured to compare a current frame of the data signal with a previous frame of the data signal, generate a pre-charging voltage signal according to a result of the comparison, and output the pre-charging voltage signal to the second conversion circuit; the second conversion circuit is configured to convert the pre-charging voltage signal into a second analog signal; the switch control circuit is configured to receive the first analog signal and the second analog signal, output the second analog signal to the output circuit at a rising edge of the control signal and output the first analog signal to the output circuit at a falling edge of the control signal; and the output circuit is configured to output the received first analog signal and second analog signal to a corresponding data line of a display panel.

Specifically, in the source driving circuit according to the embodiments of the present disclosure, the comparison circuit compares a current frame of the data signal with a previous frame of the data signal and generates a corresponding pre-charging voltage signal, the second conversion circuit converts the pre-charging voltage signal into a second analog signal after a rising edge of a control signal arrives and outputs the second analog signal, and the first conversion circuit converts the current frame of the data signal into a first analog signal after a falling edge of the control signal arrives and outputs the first analog signal corresponding to the current frame of the data signal. In this way, under the control of the control signal, the data signals are loaded onto the data line respectively in two periods of time in a frame time, which can effectively improve the charging efficiency. Further, as compared with the technical solution in the conventional art that the corresponding data signals are loaded onto the data line only after the falling edge of the control signal arrives, the source driving circuit according to the embodiments of the present disclosure can effectively improve the problem of insufficient charging, thereby enhancing the display quality of the display panel.

It will be apparent to those skilled in the art that various changes and modifications can be made to the present disclosure without departing from the spirit and scope of the present disclosure. Thus, the present disclosure is intended to embrace such variations and variations if these modifications and variations of this disclosure are within the scope of the claims of the present disclosure and the equivalent technologies thereof.

I/We claim:

1. A source driving circuit comprising: a first conversion circuit, a second conversion circuit, a comparison circuit, a switch control circuit and an output circuit, wherein:
the first conversion circuit is configured to receive a data signal of an image to be displayed, and convert the data signal into a first analog signal;
the comparison circuit is configured to compare a current frame of the data signal with a previous frame of the data signal, generate a pre-charging voltage signal according to a result of the comparison, and output the pre-charging voltage signal to the second conversion circuit;
the second conversion circuit is configured to convert the pre-charging voltage signal into a second analog signal;
the switch control circuit is configured to receive the first analog signal and the second analog signal, output the second analog signal to the output circuit at a rising edge of the control signal and output the first analog signal to the output circuit at a falling edge of the control signal; and
the output circuit is configured to output the received first analog signal and second analog signal to a corresponding data line of a display panel.

2. The source driving circuit according to claim 1, wherein the comparison circuit is further configured to:
compare the current frame of the data signal with the previous frame of the data signal; and
generate a pre-charging voltage signal that is greater than the current frame of the data signal when the current frame of the data signal is greater than the previous frame of the data signal and that is less than the current frame of the data signal when the current frame of the data signal is less than the previous frame of the data signal, and output the generated pre-charging voltage signal to the second conversion circuit.

3. The source driving circuit according to claim 1, wherein the switch control circuit comprises a first switch circuit and a second switch circuit, wherein:
the first switch circuit is configured to be turned on at the rising edge of the control signal to output the second analog signal to the output circuit; and
the second switch circuit is configured to be turned on at the falling edge of the control signal to output the first analog signal to the output circuit.

4. The source driving circuit according to claim 1, further comprising a storage circuit and a grayscale voltage generation circuit, wherein:
the storage circuit is configured to store the previous image of the data signal of the image be displayed; and
the grayscale voltage generation circuit is configured to provide a corresponding grayscale voltage when the first analog signal and the second analog signal are output to the switch control circuit, respectively.

5. The source driving circuit according to claim 1, wherein
the first conversion circuit and the second conversion circuit are digital-to-analog converters,
the comparison circuit is a comparator, and
the output circuit is an output buffer.

6. A source driving chip comprising the source driving circuit according to claim 1.

7. A source driving chip comprising the source driving circuit according to claim 2.

8. A source driving chip comprising the source driving circuit according to claim 3.

9. A source driving chip comprising the source driving circuit according to claim 4.

10. A source driving chip comprising the source driving circuit according to claim 5.

11. A display apparatus comprising the source driving chip according to claim 6.

12. A display apparatus according to claim 11, further comprising: a control signal controller, configured to increase a time interval between the rising edge and falling edge of the control signal with a transmission distance of the data signal on the data line.

13. A display apparatus comprising the source driving chip according to claim 7.

14. A display apparatus according to claim 13, further comprising: a control signal controller, configured to increase a time interval between the rising edge and falling edge of the control signal with a transmission distance of the data signal on the data line.

15. A display apparatus comprising the source driving chip according to claim 8.

16. A display apparatus according to claim 15, further comprising: a control signal controller, configured to increase a time interval between the rising edge and falling edge of the control signal with a transmission distance of the data signal on the data line.

17. A display apparatus comprising the source driving chip according to claim 9.

18. A display apparatus according to claim 17, further comprising: a control signal controller, configured to increase a time interval between the rising edge and falling edge of the control signal with a transmission distance of the data signal on the data line.

19. A display apparatus comprising the source driving chip according to claim 10.

20. A display apparatus according to claim 19, further comprising: a control signal controller, configured to increase a time interval between the rising edge and falling edge of the control signal with a transmission distance of the data signal on the data line.
